(19) United States
(12) Patent Application Publication
(10) Pub. No.: US 2016/0279904 A1
(43) Pub. Date: Sep. 29, 2016

(54) LAMINATED GLASS HAVING AT LEAST ONE CHEMICALLY TEMPERED PANE

(71) Applicant: SAINT-GOBAIN GLASS FRANCE, Courbevoie (FR)

(72) Inventors: Sandra SIENERTH, Aachen (DE); Stephan KREMERS, Heinsberg (DE); René GY, Bondy (FR)

(21) Appl. No.: 15/029,091

(22) PCT Filed: Aug. 22, 2014
(86) PCT No.: PCT/EP2014/067903

§ 371 Date: Apr. 13, 2016

(30) Foreign Application Priority Data
Oct. 23, 2013 (EP) 13189859.5

(51) Int. Cl. B32B 17/10; E06B 9/00

(52) U.S. Cl. CPC B32B 17/10036; B32B 17/10119; B32B 17/10137; B32B 17/10174; B32B 17/10761; B32B 17/1077; B32B 17/10788; E06B 9/00; B32B 2307/202; B32B 2307/212; B32B 2307/402; B32B 2307/71; E06B 2009/2417

(57) ABSTRACT

A laminated glass comprising at least one chemically tempered pane is described. The chemically tempered pane comprises a first pane and a second pane, which are connected to each other by means of an intermediate layer. The first pane is a chemically tempered glass pane having a thickness less than or equal to 2.1 mm, wherein the intermediate layer contains at least one thermoplastic connection layer and a thermoplastic carrier layer, and the carrier layer has a functional coating or functional inclusions.

The invention relates to a composite glass with at least one chemically tempered pane and functional properties, a method for its production, and the use of a carrier layer in such a composite glass.

Composite glasses are well known as glazings in the automotive sector. They are customarily made of two glass panes with a thickness of 2 mm to 3 mm, which are bonded to each other by means of a thermoplastic intermediate layer. Such composite glasses are, in particular, used as windshields and roof panels, but increasingly also as side windows and rear windows.

The automotive industry is currently endeavoring to reduce the weight of vehicles, which is associated with reduced fuel consumption. A reduction in the weight of glazings, which can be obtained in particular through reduced pane thicknesses, can make a significant contribution to this. Such thin panes have in particular thicknesses less than 2 mm. Despite the reduced pane thicknesses, the requirements for stability and break resistance of the panes must nevertheless be met.

To increase their stability, glass panes can be tempered. For the most part, in the automotive industry, the panes are thermally tempered, with the tempering generated by suitable cooling of the panes. However, in the case of thermal tempering of panes with low thicknesses, for physical reasons, lower prestressing results. Chemically tempered panes are also known in the automotive industry, for example, from DE1946358A1. Customarily, the chemical composition of the glass is altered by ion exchange in the region of the surface.

As is set forth, for example, in GB1339980A, higher pre-stresses and, thus, better stability can be obtained than by means of thermal tempering. Since the ion exchange is limited by diffusion to a surface zone, chemical tempering is, moreover, especially suitable for thin panes. Composite glasses with chemically tempered, thin panes are also known from WO2012/051038A1.

Modern glazings frequently have a functional coating. Examples of such functional coatings are, for instance. IR reflecting coatings or heatable coatings. Thermal radiation reflecting coatings are known, for example, from EP 2 141 135 A1, WO 2010115558 A1, and WO 2011105991 A1; heatable coatings, for example, from WO 03/024155 A2, US 2007/0082219 A1, and US 2007/0020465 A1. Customarily, the coatings are applied on one of the glass panes of a composite pane, in particular by cathodic sputtering.

Transferring such known coatings for thermally tempered or non-tempered panes to chemically tempered glass panes in a simple manner is not possible. The coating would have to be applied after the chemical tempering, because, otherwise, the coating interferes with the diffusion process during the ion exchange. However, due to the high temperatures during sputtering, the defined tempering would be altered by diffusion. Furthermore, undesirable thermal stresses would be introduced into the pane. For the same reason, during chemical tempering, a pane must already have its final bending, since the bending process also occurs at elevated temperatures. Sputtering onto curved panes is, however, technically very complicated and, consequently, costly.

There is thus a need for composite glasses that have chemically tempered panes as well as functional coatings. The object of the present invention is to provide such an improved composite glass.

The object of the present invention is accomplished according to the invention by a composite glass with at least one chemically tempered pane according to claim 1. Preferred embodiments emerge from the subclaims.

The composite glass according to the invention with at least one chemically tempered pane comprises at least a first pane and a second pane, which are bonded to each other via an intermediate layer, wherein
the first pane is a chemically tempered glass pane with a thickness less than or equal to 2.1 mm,
the intermediate layer contains at least one thermoplastic bonding layer and one thermoplastic carrier layer, and
the carrier layer has a functional coating or functional inclusions.

The composite glass according to the invention is preferably intended, in an opening, for example, a window opening of a vehicle or of a building, to separate the interior from the external environment. The pane of the composite glass facing the interior is referred to as the inner pane. The pane facing the external environment is referred to as the outer pane.

The advantage of the composite glass according to the invention resides in the carrier layer with the functional coating or the functional inclusions in the intermediate layer. The carrier layer has, as a result, a functionality (or functional properties). By means of the carrier layer according to the invention, the composite glass can, consequently, be provided with an additional functionality (or additional functional properties), without having to apply a coating on the first or the second pane. The disadvantages described above can, consequently, be avoided.

The terms “an additional functionality (or additional functional properties)” mean, in the context of the invention, all properties of the composite glass that go beyond the conventional function as the window pane enabling vision through it. In particular, it means an effect (such as an absorbing, attenuating, or reflecting effect) on ranges of electromagnetic radiation, a heating function, an antenna function, or splinter protection effect.

In the finished composite glass, the functional coating is arranged between the carrier layer and a bonding layer. The functional coating can, in principle, be any functional coating known to the person skilled in the art that is suitable to be applied on a carrier film. The functional coating can, for example, be an IR reflecting or absorbing coating, a UV reflecting or absorbing coating, a coloring coating, a low emissivity coating (so-called low E coating), a heatable coating, a coating with antenna function, a coating with splinter-binding action (splinter-binding coating), or a coating for shielding against electromagnetic radiation, for example, radar radiation.

In the context of the invention, “low emissivity coating” refers, in particular, to a coating that provides the composite glass with an emissivity less than or equal to 50%, preferably less than or equal to 25%. In the context of the invention, the term “emissivity” means the normal emission level at 283 K in accordance with the Standard EN 12898.

The functional coating can be applied to the carrier film over its entire area. However, the functional coating can also be applied to the carrier film in a pattern, for example, as printed antenna conductors or heating fields.

The functional coating can consist of a single, homogeneous layer. However, the coating can also comprise a plurality of individual layers that are arranged one above another in a planar manner on the carrier film.

In a preferred embodiment, the coating according to the invention is an electrically conductive coating. Thus, it is possible to realize, in particular, a low emissivity coating, an IR reflecting or a heatable coating. Such an electrically conductive coating has at least one electrically conductive layer. Additionally, the coating can have dielectric layers which serve, for example, to regulate sheet resistance, to protect against corrosion, or to reduce reflection. The conductive layer preferably includes silver or an electrically conductive oxide (transparent conductive oxide TCO) such as indium tin oxide (ITO). The conductive layer preferably has a thickness of 10 nm to 200 nm. Typical dielectric layers contain oxides or nitrides, for example, silicon nitride, silicon oxide, aluminum nitride, aluminum oxide, zinc oxide, or titanium oxide. The electrical conductivity of the coating depends on the use in the individual case and is then selected accordingly and adjusted by the person skilled in the art. The specific resistance is preferably less than 5 Ωm, for example, roughly 3 Ωm for IR reflecting coatings. For effective heatable coatings, the specific resistance is preferably less than 1 Ωm, particularly preferably less than 0.7 Ωm, most particularly preferably less than 0.5 Ωm.

Alternatively to the functional coating, the carrier film can also be provided with functional inclusions. The functional inclusions can have, in particular. IR absorbing, UV absorbing, or coloring properties. The functional inclusions can be, in particular, organic or inorganic ions, compounds, aggregates, molecules, crystals (for example, nanocrystals), pigments, or dyes.

The carrier layer is preferably formed by a thermoplastic film. The thermoplastic film is provided with the functional coating or the functional inclusions and arranged, for production of the composite glass, between the first and the second pane and embedded in the intermediate layer by lamination. The thermoplastic film can be a monolithic plastic film or can consist of a plurality of individual layers (film sandwich).

The carrier layer preferably contains at least polyethylene terephthalate (PET), polyethylene (PE), or mixtures or copolymers or derivatives thereof. This is particularly advantageous for the handling, the stability, and the optical properties of the carrier layer.

The carrier layer preferably has a thickness of 5 μm to 1 mm, particularly preferably of 5 μm to 500 μm, most particularly preferably of 10 μm to 200 μm, and especially of 12 μm to 75 μm. Carrier layers with these thicknesses can be advantageously provided in the form of flexible and, at the same time, stable films, which can be readily handled.

The intermediate layer contains, besides the carrier layer, at least one thermoplastic bonding layer. The bonding layer effects the durably stable adhesive bonding of the first pane and the second pane. The bonding layer is preferably formed by a thermoplastic film. The bonding layer preferably contains at least polyvinyl butyral (PVB), ethylene vinyl acetate (EVA), polyurethane (PU), or mixtures or copolymers or derivatives thereof. The bonding layer preferably has a thickness of 0.2 mm to 1 mm, particularly preferably of 0.3 mm to 0.9 mm, for example, 0.38 mm, 0,76 mm or 0.86 mm, this is advantageous with regard to the break stability and a low total thickness of the composite glass.

The carrier layer is, in one embodiment of the invention, provided with an adhesive layer of an adhesive, for example, silicon adhesive and attached by means of this adhesive on the Out pane or the second pane. In an alternative embodiment, the carrier layer is arranged between a first and a second thermoplastic bonding layer.

The carrier layer can have the same area as the composite glass and extend to the lateral edges of the composite glass. However, the carrier layer can also have a smaller area than the composite glass such that a peripheral edge region with a width of preferably 5 mm to 20 mm is not provided with the carrier layer. The carrier layer is thus protected within the intermediate layer against contact with the surrounding atmosphere, which is advantageous particularly for corrosion-sensitive functional coatings.

A peripheral edge region of one of the panes of the composite glass, in particular of the outer pane, can be provided with an opaque masking print, preferably a screen print. Such screen prints occur in particular in the automotive industry, by means of which an adhesive with which the composite glass is bonded to the vehicle body is protected against UV radiation. It can also be desirable for aesthetic reasons, for example, in order to conceal the side edge of the carrier layer or, optionally, electrical connections of the functional coating from the view of an observer of the composite glass.

The first pane can, in principle, have any chemical composition known to the person skilled in the art. The first pane can contain, for example, soda lime glass or borosilicate glass or be made from these glasses. The first pane must, of course, be suitable to be chemically tempered, and, in particular, have a content of alkali elements suitable therefor, preferably sodium. The first pane can contain, for example, from 40 wt.-% to 90 wt.-% silicon oxide (SiO₂), from 0.5 wt.-% to 10 wt.-% aluminum oxide (Al₂O₃), from 1 wt.-% to 20 wt.-% sodium oxide (Na₂O), from 0.1 wt.-% to 15 wt.-% potassium oxide (K₂O), from 0 wt.-% to 10 wt.-% magnesium oxide (MgO), from 0 wt.-% to 10 wt.-% calcium oxide (CaO), and from 0 wt.-% to 15 wt.-% boron oxide (B₂O₃). The first pane can, moreover, contain other constituents and impurities.

It has, however. surprisingly been found that certain chemical compositions of the first pane are particularly suitable to be subjected to chemical tempering. This expresses itself in a high speed of the diffusion process, which results in an advantageously low time outlay for the tempering process, and yields large tempered depths (compressive stress depths), which yields stable and fracture resistant glasses. In the context of the invention, these compositions are preferred.

The first pane advantageously contains an aluminosilicate glass. The first pane preferably contains from 50 wt.-% to 85 wt.-% silicon oxide (SiO₂), from 3 wt.-% to 10 wt.-% aluminum oxide (Al₂O₃), from 8 wt.-% to 18 wt.-% sodium oxide (Na₂O), from 5 wt.-% to 15 wt.-% potassium oxide (K₂O), from 4 wt.-% to 14 wt.-% magnesium oxide (MgO), from 0 wt.-% to 10 wt.-% calcium oxide (CaO), and from 0 wt.-% to 15 wt.-% boron oxide (B₂O₃). The first pane can, moreover, contain other constituents and impurities.

The first pane particularly preferably contains at least from 55 wt.-% to 72 wt.-% silicon oxide (SiO₂), from 5 wt.-% to 10 wt.-% aluminum oxide (Al₂O₃), from 10 wt.-% to 15 wt.-% sodium oxide (Na₂O), from 7 wt.-% to 12 wt.-% potassium oxide (K₂O), and from 6 wt.-% to 11 wt.-% magnesium oxide (MgO). The first pane can, moreover, contain other constituents and impurities.

The first pane most particularly preferably contains at least from 57 wt.-% to 65 wt.-% silicon oxide (SiO₂), from 7 wt.-% to 9 wt.-% aluminum oxide (Al₂O₃), from 12 wt.-% to 14 wt.-% sodium oxide (Na₂O), from 8.5 wt.-% to 10.5 wt.-% potassium oxide (K₂O), and from 7.5 wt.-% to 9.5 wt.-% magnesium oxide (MgO). The first pane can, moreover, contain other constituents and impurities.

Surprisingly, a further advantage of panes with the preferred compositions has additionally been found, Such panes are suitable to be congruently bent together with panes of conventional soda lime glass (also referred to as “standard glass”). Similar thermal properties are responsible for this such that the two types of glass are bendable in the same temperature range, i.e., roughly from 450° C. to 700° C. As is sufficiently known to the person skilled in the art, congruently bent panes are particularly suitable due to their optimally matched shape to be bonded to form a composite glass. A first pane with the preferred chemical compositions is thus particularly suited to be used in a composite glass with a second pane of a different composition, in particular made of soda lime glass.

The stability of the first pane can be improved by suitable values and local distributions of stresses, which are generated by incorporation of ions during chemical tempering.

In an advantageous embodiment, the first pane has a surface compressive stress greater than 100 MPa, preferably greater than 250 MPa, and particularly preferably greater than 350 MPa.

The compressive stress depth of the first pane is preferably greater than 40 μm, particularly preferably greater than 100 μm, most particularly preferably between 100 μm and 150 μm. This is advantageous with regard to the break resistance of the pane, on the one hand, and a less time-consuming tempering process, on the other. The compressive stress depth of the first pane is in particular at least one tenth of the thickness of the first pane, preferably at least one sixth of the thickness of the first pane, for example, roughly one fifth of the thickness of the first pane. In the context of the invention, the term “compressive stress depth” means the depth measured from the surface of the pane to which the pane is under compressive stresses in an amount greater than 0 MPa.

The thickness of the first pane is preferably from 0.3 mm to 2.1 mm, particularly preferably from 0.5 mm to 2.1 mm, most particularly preferably from 0.5 to 1.5 mm, and in particular from 0.6 mm to 1.0 mm, for example, roughly 0.7 mm. The advantage resides in special stability and in a low weight of the composite glass. Chemical tempering is especially of interest for panes with such low thicknesses.

In one embodiment of the invention, the second pane also contains glass and is also chemically tempered. Thus, composite glasses with especially low thicknesses and especially high tempering values can be obtained. The thickness of the chemically tempered pane as a second pane is preferably from 0.3 mm to 2.1 mm, particularly preferably from 0.5 mm to 2.1 mm, most particularly preferably from 0.5 to 1.5 mm, and, in particular, from 0.6 mm to 1.0 mm, for example, roughly 0.7 mm. Preferred chemical compositions for the second pane correspond to the compositions described above in connection with the first pane. Preferably, the first and the second pane have the same chemical composition, which is particularly advantageous with regard to simple and economical production of the composite glass.

In another embodiment of the invention, the second pane contains glass, preferably soda lime glass or borosilicate glass, and is not tempered. To improve the stability, the second pane in this embodiment is preferably thicker than the first pane. The thickness of the second pane is preferably from 1.5 mm to 5 mm, particularly preferably from 2 mm to 3 mm, for example, 2.1 mm or 2.6 mm. In one embodiment, the first pane is the inner pane of the composite glass and the second pane is the outer pane. This is particularly advantageous with regard to the stone impact resistance of the pane against a sharp stone. In an alternative embodiment, the first pane is the outer pane of the composite glass and the second pane is the inner pane. This is particularly advantageous with regard to the scratch resistance of the pane.

In another embodiment, the second pane is a plastic pane, which preferably contains at least polycarbonate (PC), polymethyl methacrylate (PMMA), or mixtures or copolymers or mixtures thereof. The thickness of the plastic pane as a second pane is preferably from 1.5 mm to 5 mm, particularly preferably from 2 mm to 3 mm. By means of a plastic pane, a lower weight of the composite glass can advantageously be obtained despite greater thickness. Here again, the first pane can be the inner pane or also the outer pane, with the first pane preferably being the outer pane for reasons of scratch resistance.

The first pane, the second pane, the carrier layer, and/or the bonding layer can be clear and colorless, but also tinted or colored. For example, the carrier layer or the bonding layer can contain organic or inorganic pigments, dyes, or inks.

The composite glass according to the invention can be flat. Flat composite glasses occur in particular in the architectural sector as well as in large area glazings of buses, trains, or tractors. The composite glass according to the invention can, however, also be slightly or greatly curved in one or a plurality of spatial directions. Curved panes occur, for example, in glazings in the automotive sector, wherein typical radii of curvature are in the range from roughly 10 cm to roughly 40 m.

The invention further comprises a method for producing a composite glass with at least one chemically tempered pane, wherein

(a) a first pane made of glass with a thickness less than or equal to 2.1 mm is chemically tempered,

(b) a thermoplastic carrier layer provided with at least one functional coating or functional inclusions and a bonding layer are arranged in a planar manner between the first pane and a second pane, and

(c) the first pane and the second pane are bonded to each other by lamination, wherein at least the carrier layer and the bonding layer form an intermediate layer.

The pane is preferably produced as flat glass in the float process and cut to the desired size and shape.

The first pane preferably receives its final three-dimensional shape even before chemical tempering. For this, the first pane is subjected to a bending process at elevated temperatures, for example, at 500° C. to 700° C. Preferably, the first pane and the second pane are congruently bent jointly (i.e., simultaneously and by the same tool), since, thus, the shape of the panes is optimally matched to each other for the subsequent lamination.

After bending, the pane is slowly cooled. Excessively rapid cooling creates thermal stresses in the pane that can result in shape changes during the subsequent chemical tempering. The cooling rate is preferably from 0.05° C./sec to 0.5° C./sec until cooling to a temperature of 400° C., particularly preferably from 0.1-0.3° C./sec. By means of such slow cooling, thermal stresses in the glass which result in particular in optical defects as well as in a negative impact on the subsequent chemical tempering can be prevented. Thereafter, it can be further cooled even at higher cooling rates, because below 400° C., the risk of generating thermal stresses is low.

The chemical tempering is preferably done at a temperature of 300° C. to 600° C., particularly preferably 400° C. to 500° C. The first pane is treated with a salt melt, for example, immersed in the salt melt. During the treatment, in particular, sodium ions of the glass are exchanged for larger ions, in particular larger alkali ions, creating the desired surface compressive stresses. The salt melt is preferably the melt of a potassium salt, particularly preferably potassium nitrate (KNO₃) or potassium sulfate (KSO₄), most particularly preferably potassium nitrate (KNO₃).

The ion exchange is determined by the diffusion of the alkali ions. The desired values for the surface compressive stresses and the compressive stress depths can consequently be adjusted, in particular by the temperature and the duration of the tempering process. Customary times for the duration are from 2 hours to 48 hours.

After the treatment with the salt melt, the pane is cooled to room temperature. Then, the pane is cleaned, preferably with sulfuric acid (H₂SO₄).

The carrier layer and the bonding layer are preferably provided as films.

The film that forms the carrier layer can, for example, be provided with the layer of an adhesive and glued on the first pane or the second pane. Then, the film that forms the bonding layer is arranged on the carrier layer, and the second pane is arranged on the bonding layer.

The film that forms the carrier layer can also, for example, be placed between two thermoplastic bonding layers.

Of course, the intermediate layer can also include other layers that are placed in the composite before lamination.

The production of the composite glass by lamination is done with conventional methods known per se to the person skilled in the art, for example, autoclave methods, vacuum bag methods, vacuum ring methods, calender methods, vacuum laminators, or combinations thereof. The bonding of the first pane and second pane is customarily done under the action of heat, vacuum, and/or pressure.

The composite glass according to the invention with at least one chemically tempered pane is preferably used in buildings, in particular in the access area or the window area, as a built-in component in furniture and devices, or in means of transportation for travel on land, in the air, or on water, in particular in trains, ships, and motor vehicles, for example, as a windshield, roof panel, rear window, or side window.

The invention further comprises the use of a thermoplastic carrier film provided with a functional coating or functional inclusion in the intermediate layer of a composite glass according to the invention with at least one chemically tempered pane, in order to provide the composite glass with the functional properties.

In the following, the invention is explained in detail with reference to drawings and exemplary embodiments. The drawings are schematic representations and not true to scale. The drawings in no way restrict the invention.

They depict:

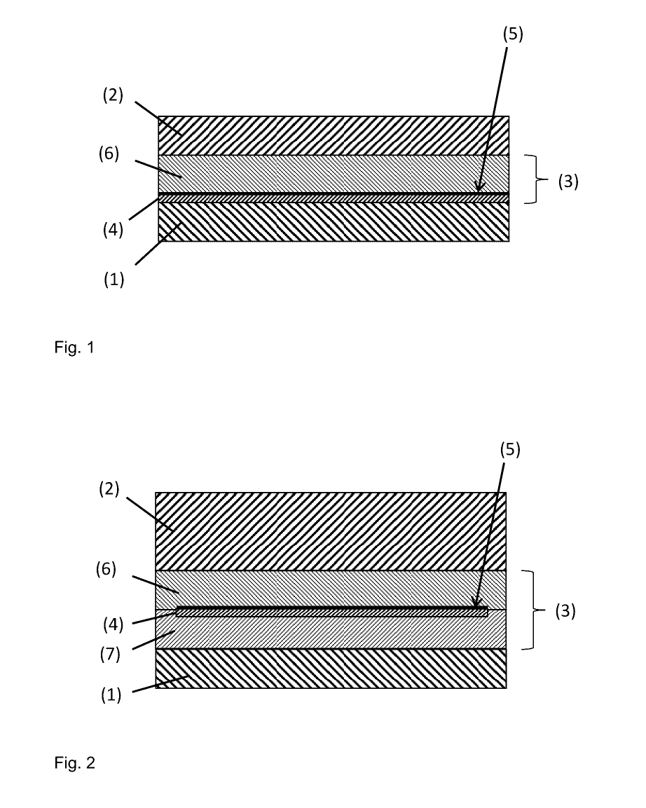

FIG. 1 a cross-section through an embodiment of the composite glass according to the invention,

FIG. 2 a cross-section through another embodiment of the composite glass according to the invention, and

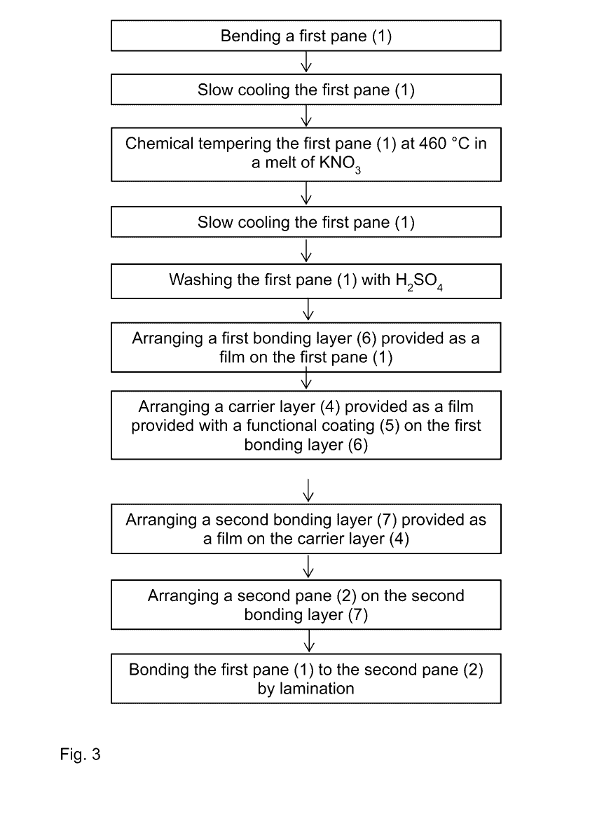

FIG. 3 a flowchart of an embodiment of the method according to the invention.

FIG. 1 depicts a composite glass according to the invention, which is made of a first pane 1 and a second pane 2, which are bonded to each other via an intermediate layer 3. The composite glass is intended as a roof panel of a motor vehicle, wherein, in the installed position, the first pane 1 is the inner pane and the second pane 2 is the outer pane.

The first pane 1 and the second pane 2 are made of chemically tempered glass and have, in each case, a thickness of only 0.7 mm. The surface compressive stress of the panes 1, 2 is roughly 400 MPa and the compressive stress depth roughly 150 μm. Due to the chemical tempering, the panes 1, 2 are, despite their low thickness, adequately stable. The chemical composition of the panes 1, 2 is presented in Table 1, with the missing portion resulting from admixtures and impurities. The composition is particularly suited to being subjected to chemical tempering.

TABLE 1

| Constituent | wt.-% |
|---|---|
| SiO₂ | 60.7 |
| Al₂O₃ | 7.7 |
| Na₂O | 13.1 |
| K₂O | 9.6 |
| MgO | 8.4 |

As a result of the low thickness of the panes 1, 2, which is significantly less than the customary standard glass thicknesses of roughly 2.1 mm or 2.6 mm, the composite glass has a significantly lower weight than conventional composite glasses. The chemically tempered panes 1, 2 can, however, not be provided in a simple manner with a functional coating, for example, by sputtering, as is customary for non-tempered and thermally tempered panes.

The intermediate layer 3 includes a thermoplastic bonding layer 6 and a thermoplastic carrier layer 4, which is provided with a functional coating 5. The bonding layer is made of PVB and has a thickness of 0.76 mm. The carrier layer 4 is made of PET and has a thickness of 50 μm. The functional coating 5 is a low emissivity coating (low E coating). The functional coating 5 contains an electrically conductive layer, which is made of ITO and has a thickness of roughly 100 nm. By means of the carrier layer 4, the composite glass is provided with the low E function, without one of the panes 1, 2 having to be coated.

The carrier layer 4 and the bonding layer 6 were provided at the time of production of the composite glass as film. The carrier layer 4 is bonded to the first pane 1 via an adhesive (not shown). The coating 5 is arranged on the surface of the carrier layer 4 facing away from the first pane 1. The bonding layer 6 effects the durably stable bonding to the carrier film 4 between the second pane 2 and the first pane 1.

Alternatively to the coating 5, it is also conceivable to provide the carrier layer 4 with, for example. IR reflecting properties by means of functional inclusions.

FIG. 2 depicts another embodiment of the composite glass according to the invention. The chemically tempered first pane 1 is configured as in FIG. 1, with a thickness of 0.7 mm and the composition from Table 1.

The second pane 2, which is the outer pane, is, in contrast to the embodiment of FIG. 1, not a chemically tempered thin pane, but rather a non-tempered pane made of soda lime glass with the standard thicknesses of 2.1 mm. It is a particular advantage of the first pane 1 with the chemical composition from Table 1 that it can be subjected together with a pane made of soda lime glass to a bending process, which is advantageous in the context of simple and economical production of the composite glass.

The intermediate layer contains the carrier layer 4 with the functional coating 5. The carrier layer 4 is, in contrast to FIG. 1, not arranged directly on the first pane 1, but, instead, between a first thermoplastic bonding layer 6 and a second thermoplastic bonding layer 7. The bonding layers 6, 7 are in each case formed from a 0.76-mm-thick PVB film.

The carrier layer 4 is cut back relative to the area of the composite glass. This means that the carrier layer 4 does not extend to the lateral edge of the composite glass, but, instead, has a peripheral distance from the lateral edge of, for example, 10 mm. The carrier layer 4 is thus protected against corrosion by the bonding layers 6, 7, which have the same area as the panes 1, 2 and are glued directly to each other in the edge region.

In the case of a nonsymmetrical structure of the composite glass as in FIG. 2, it is equally possible for the chemically tempered first pane 1 to form the outer pane. It is likewise possible to combine the chemically tempered first pane 1 with a second pane 2 made of plastic.

FIG. 3 depicts a flowchart of an exemplary embodiment of the method according to the invention for producing a composite glass according to the invention. A first pane 1 is provided as flat float glass with the chemical composition from Table 1. The first pane 1 is first brought into its final three-dimensional shape by a bending process. Preferably, a second pane 2, which is intended for bonding to the first pane 1, is congruently bent together with the first pane 1. It is a particular advantage of the pane 1 with the composition indicated that it can be bent together with the second pane 2, if the second pane 2 does not have the same composition, but, instead, is made, for example, from conventional soda lime glass.

The first pane 1 is cooled slowly after bending in order to avoid thermal stresses. A suitable cooling rate is, for example, 0.1° C./sec. The first pane 1 is then treated for a period of a few hours, for example, 4 hours, at a temperature of 460° C. with a melt of potassium nitrate and thus chemically tempered. The treatment effects a diffusion-driven exchange of sodium ions by larger potassium ions via the surface of the glass. Surface compressive stresses are thus generated. The first pane 1 is subsequently cooled and then washed with sulfuric acid to remove residues of the potassium nitrate.

A first thermoplastic film made of PVB, which forms a first bonding layer 6 in the composite glass, is placed on that surface of the first pane 1 that is intended to face the second pane in the composite glass. Then, a film that is provided with a functional coating 5 is placed on the first bonding layer 6. A carrier layer 4 is formed in the composite glass by the film.

A second thermoplastic film made of PVB, which forms a second bonding layer 7 in the composite glass, is placed on the carrier layer 4. The second pane 2 is arranged on the bonding layer 7. Then, the composite of panes is laminated in a conventional manner, for example, by a vacuum bag method.

Instead of being placed between a first bonding layer and a second bonding layer, the carrier film 4 can, alternatively, be glued on a pane surface. For this, the film is preferably provided prefabricated with an adhesive layer on the surface facing away from the functional coating.

### LIST OF REFERENCE CHARACTERS

(1) first pane

(2) second pane

(3) intermediate layer

(4) carrier layer

(5) functional coating

(6) bonding layer

(7) second bonding layer

1.-15. (canceled)

16. A composite glass with at least one chemically tempered pane, comprising:
a first pane,
wherein the first pane is a chemically tempered glass pane with a thickness less than or equal to 2.1 mm;
a second pane; and
an intermediate layer configured to bond the second pane to the first pane,
wherein the intermediate layer contains at least one thermoplastic bonding layer and one thermoplastic carrier layer, and
wherein the thermoplastic carrier layer has a functional coating or has functional inclusions.

17. The composite glass according to claim 16, wherein the thermoplastic carrier layer has a functional coating, which is an IR reflecting or absorbing coating, a UV reflecting or absorbing coating, a coloring coating, a low emissivity coating, a heatable coating, a coating with antenna function, a splinter-binding coating, or a coating for shielding against electromagnetic radiation.

18. The composite glass according to claim 17, wherein the functional coating contains an electrically conductive layer.

19. The composite glass according to claim 18, wherein the electrically conductive layer of the functional coating contains silver or a transparent conductive oxide.

20. The composite glass according to claim 17, wherein the functional coating has a thickness of 10 nm to 200 nm.

21. The composite glass according to claim 16, wherein the thermoplastic carrier layer has functional inclusions with IR absorbing, UV absorbing, or coloring properties.

22. The composite glass according to claim 16, wherein the thermoplastic carrier layer includes organic or inorganic ions, compounds, aggregates, molecules, crystals, pigments, or dyes.

23. The composite glass according to claim 16, wherein the thermoplastic carrier layer has a thickness of 5 μm to 1 mm.

24. The composite glass according to claim 16, wherein the thermoplastic carrier layer has a thickness of 5 μm to 500 μm.

25. The composite glass according to claim 16, wherein the thermoplastic carrier layer has a thickness of 10 μm to 200 μm.

26. The composite glass according to claim 16, wherein the thermoplastic carrier layer has a thickness of 12 μm to 75 μm.

27. The composite glass according to claim 16, wherein the thermoplastic carrier layer contains polyethylene terephthalate (PET), polyethylene (PE), or mixtures or copolymers or derivatives thereof.

28. The composite glass according to claim 16, wherein the thermoplastic bonding layer contains polyvinyl butyral (PVB), ethylene vinyl acetate (EVA), polyurethane (PU), or mixtures or copolymers or derivatives thereof; and wherein the bonding layer has a thickness of 0.2 mm to 1 mm.

29. The composite glass according to claim 16, wherein the first pane contains from 55 wt.-% to 72 wt.-% silicon oxide (SiO₂), from 5 wt.-% to 10 wt.-% aluminum oxide (Al₂O₃), from 10 wt.-% to 15 wt.-% sodium oxide (Na₂O), from 7 wt.-% to 12 wt.-% potassium oxide (K₂O), and from 6 wt.-% to 11 wt.-% magnesium oxide (MgO).

30. The composite glass according to claim 16, wherein the first pane has a surface compressive stress greater than 100 MPa, and a compressive stress depth greater than 40 μm.

31. The composite glass according to claim 16, wherein the first pane has a surface compressive stress greater than 350 MPa, and a compressive stress depth greater than 150 μm.

32. The composite glass according to claim 16, wherein the first pane has a thickness of 0.3 mm to 2.1 mm.

33. The composite glass according to claim 16, wherein the second pane is a chemically tempered glass pane having a thickness of 0.3 mm to 2.1 mm.

34. The composite glass according to claim 16, wherein the first pane has a thickness of 0.6 mm to 1.0 mm, and wherein the second pane is a chemically tempered glass pane having a thickness of 0.6 mm to 1.0 mm.

35. The composite glass according claim 16, wherein the second pane is a non-tempered glass pane or a plastic pane, and wherein the second pane has a thickness of 1.5 mm to 5 mm.

36. A method for producing a composite glass with at least one chemically tempered pane, comprising:
chemically tempering a first pane made of glass;
providing a first thermoplastic bonding layer;
providing a thermoplastic carrier layer having at least one functional coating or functional inclusions;
arranging in a planar manner the first thermoplastic bonding layer and the thermoplastic carrier layer between the first pane and a second pane; and
bonding by lamination the first pane to the second pane, wherein at least the first thermoplastic bonding layer and the thermoplastic carrier layer form an intermediate layer.

37. The method according to claim 36, further including gluing the thermoplastic carrier layer to the first pane or to the second pane.

38. The method according to claim 36, further including, prior to arranging in a planar manner, providing a second thermoplastic bonding layer and placing the thermoplastic carrier layer between the first thermoplastic bonding layer and the second thermoplastic bonding layer.

39. A method for using a composite glass with at least one chemically tempered pane, comprising:
providing a composite glass according to claim 16; and
installing the composite glass in a windshield, roof panel, rear window, or side window of a motor vehicle.

40. A method for using a composite glass with at least one chemically tempered pane, comprising:
providing a composite glass according to claim 16; and
installing the composite glass in a window of a building.
